(19) United States
(12) Patent Application Publication
(10) Pub. No.: US 2024/0303841 A1
(43) Pub. Date: Sep. 12, 2024

(54) MONOCULAR IMAGE DEPTH ESTIMATION WITH ATTENTION

(71) Applicant: QUALCOMM Incorporated, San Diego, CA (US)

(72) Inventors: Rajeev YASARLA, San Diego, CA (US); Hong CAI, San Diego, CA (US); Jisoo JEONG, San Diego, CA (US); Risheek GARREPALLI, San Diego, CA (US); Yunxiao SHI, San Diego, CA (US); Fatih Murat PORIKLI, San Diego, CA (US)

(21) Appl. No.: 18/538,869

(22) Filed: Dec. 13, 2023

Related U.S. Application Data
(60) Provisional application No. 63/488,964, filed on Mar. 7, 2023.

(51) Int. Cl. G06T 7/50; G06T 7/246; G06T 11/60; G06V 10/44; G06V 10/62

(52) U.S. Cl. CPC G06T 7/50; G06T 7/246; G06T 11/60; G06V 10/44; G06V 10/62

(57) ABSTRACT

Disclosed are systems and techniques for capturing images (e.g., using a monocular image sensor) and detecting depth information. According to some aspects, a computing system or device can generate a feature representation of a current image and update accumulated feature information for storage in a memory based on a feature representation of a previous image and optical flow information of the previous image. The accumulated feature information can include accumulated image feature information associated with a plurality of previous images and accumulated optical flow information associated of the plurality of previous images. The computing system or device can obtain information associated with relative motion of the current image based on the accumulated feature information and the feature representation of the current image. The computing system or device can estimate depth information for the current image based on the information associated with the relative motion and the accumulated feature information.

### CROSS-REFERENCE TO RELATED APPLICATIONS

This application claims priority to U.S. Provisional Patent Application No. 63/488,964, filed Mar. 7, 2023, which is hereby incorporated by reference, in its entirety and for all purposes.

### FIELD

The present application is related to capturing and processing images. For example, according to some aspects, systems and techniques are described for capturing images using a monocular image sensor and detecting depth information.

### BACKGROUND

Multimedia systems are widely deployed to provide various types of multimedia communication content such as voice, video, packet data, messaging, broadcast, and so on. These multimedia systems may be capable of processing, storage, generation, manipulation, and rendition of multimedia information. Examples of multimedia systems include mobile devices, game devices, entertainment systems, information systems, virtual reality systems, model and simulation systems, and so on. These systems may employ a combination of hardware and software technologies to support the processing, storage, generation, manipulation, and rendition of multimedia information, for example, client devices, capture devices, storage devices, communication networks, computer systems, and display devices.

### SUMMARY

In some examples, systems and techniques are described for capturing images. For example, the systems and techniques can be used for capturing images using a monocular image sensor and detecting depth information. According to at least one example, a method includes: generating a feature representation of a current image; updating accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images; obtaining information associated with relative motion of the current image based on the accumulated feature information and the feature representation of the current image; and estimating depth information for the current image based on the information associated with the relative motion and the accumulated feature information.

In another example, an apparatus for processing one or more images is provided. The apparatus includes one or more memories configured to store data associated with at least a current image and one or more processors (e.g., implemented in circuitry) coupled to the one or more memories and configured to: generate a feature representation of a current image; update accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images; obtain information associated with relative motion of the current image based on the accumulated feature information and the feature representation of the current image; and estimate depth information for the current image based on the information associated with the relative motion and the accumulated feature information.

In another example, a non-transitory computer-readable medium is provided that has stored thereon instructions that, when executed by one or more processors, cause the one or more processors to: generate a feature representation of a current image; update accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images; obtain information associated with relative motion of the current image based on the accumulated feature information and the feature representation of the current image; and estimate depth information for the current image based on the information associated with the relative motion and the accumulated feature information.

In another example, an apparatus for processing one or more images is provided. The apparatus includes: means for generating a feature representation of a current image; means for updating accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images; means for obtaining information associated with relative motion of the current image based on the accumulated feature information and the feature representation of the current image; and means for estimating depth information for the current image based on the information associated with the relative motion and the accumulated feature information.

In some aspects, one or more of the apparatuses described herein is, is part of, and/or includes a wireless communication device, a mobile device (e.g., a mobile telephone and/or mobile handset and/or so-called “smartphone” or another mobile device), an extended reality (XR) device (e.g., a virtual reality (VR) device, an augmented reality (AR) device, or a mixed reality (MR) device) such as a head-mounted device (HMD) device, a vehicle or a computing device or component of a vehicle, a wearable device, a camera, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyroscopes, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A, FIG. 1B, and FIG. 1C are diagrams illustrating example configurations for an image sensor of an image capture device, in accordance with aspects of the present disclosure.

FIG. 2 is a block diagram illustrating an architecture of an image capture and processing device, in accordance with aspects of the present disclosure.

FIG. 3 is a block diagram illustrating an example of an image capture system, in accordance with aspects of the present disclosure.

FIG. 4 is a block diagram of an image capture system that uses attention to estimate depth information, in accordance with some aspects of the disclosure.

FIG. 5 is a conceptual diagram of execution of an image capture system to estimating depth information using attention, in accordance with some aspects of the disclosure.

FIG. 6 is a conceptual diagram of a feature detection engine of a depth estimator, in accordance with some aspects of the disclosure.

FIG. 7 is a conceptual diagram of an attention engine of a depth estimator, in accordance with some aspects of the disclosure.

FIG. 8 is an image captured by an image capture system, in accordance with some aspects of the disclosure.

FIG. 9 is an illustration of depth information determined by an image capture system, in accordance with some aspects of the disclosure.

FIG. 10 is a flowchart illustrating an example method for capturing images in low light conditions in accordance with aspects of the present disclosure.

FIG. 11 is an illustrative example of a deep learning neural network that can be used to implement the machine learning-based alignment prediction, in accordance with aspects of the present disclosure.

FIG. 12 is an illustrative example of a convolutional neural network (CNN), in accordance with aspects of the present disclosure.

FIG. 13 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure the post-processing of one or more image frames, such as alterations to contrast, brightness, saturation, sharpness, levels, curves, or colors. For example, settings or parameters can be applied to a processor (e.g., an image signal processor (ISP)) for processing the one or more image frames captured by the image sensor.

Depth information of a scene may be needed by a device that includes image sensors for various functions, such as navigating the scene autonomously. For example, an autonomous vehicle performs various types of sensing to understand the environment to safely navigate the environment. Existing depth estimation approaches include monocular depth estimation, stereo depth estimation, and video depth estimation. Monocular depth estimation is the derivation of depth using a single image, which may not be reliable and it ignores temporal information. Stereo depth estimation is the derivation of depth using multiple image sensors, which are difficult to configure and require advanced processing to synthesize the images. Video depth estimation derives depth based on video frames.

The existing solutions rely on a cost volume structure, which involves computing a cost volume by comparing corresponding pixels in each pair of frames. The cost volume contains a measure of similarity between the pixels in each pair of frames, which can be used to estimate the depth of the scene. To obtain accurate depth estimates, additional post-processing techniques such as filtering and regularization may be applied to the disparity map. Cost volume-based methods are widely used, but are computationally expensive. Recurrent neural networks (RNNs) may also be implemented to identify depth, but RNNs lose memory and cause significant errors in the depth information stream.

In some aspects, systems, apparatuses, processes (also referred to as methods), and computer-readable media (collectively referred to herein as “systems and techniques”) are described for improving depth estimation in a monocular imaging system. The systems and techniques can generate a depth information for each input image without any delay. In some aspects, the systems and techniques use accumulated features detected in images and continually updates the accumulated features to prune immaterial features and store recent features.

In one aspect, the systems and techniques generate a feature representation of a current image and update accumulated feature information for storage in a memory based on a feature representation of a previous image and optical flow information of the previous image. The accumulated feature information comprises accumulated image feature information associated with a plurality of previous images and accumulated optical flow information associated of the plurality of previous images.

After updating the accumulated feature information, the systems and techniques obtain relative motion information of the image based on the accumulated feature information and the feature representation of the current image. The relative motion information is identified by convoluting the accumulated optical flow information associated of the plurality of previous images to learn positional encodings of features in the accumulated image feature information associated with the plurality of previous images.

For instance, the systems and techniques can generate a feature representation of a current image accumulated optical flow information associated of the plurality of previous images, performing a self-attention to identify correlated features, and performing a cross-attention to fuse the correlated features with the feature representation of a current image. The cross-attention fuses the current image with the previous features and may be used to generate depth information. The systems and techniques use an encoder-decoder structure with an adaptive memory that stores recent features and can produce a depth estimation for an input image without waiting for another image or other expensive computation.

Various aspects and examples of the systems and techniques will be described below with respect to the figures. Illustrative aspects of the present disclosure are provided in Appendix A provided herewith.

In general, image sensors include one or more arrays of photodiodes or other photosensitive elements. Each photodiode measures an amount of light that eventually corresponds to a particular pixel in the image produced by the image sensor. In some cases, different photodiodes may be covered by different color filters of a color filter array and may thus measure light matching the color of the color filter covering the photodiode.

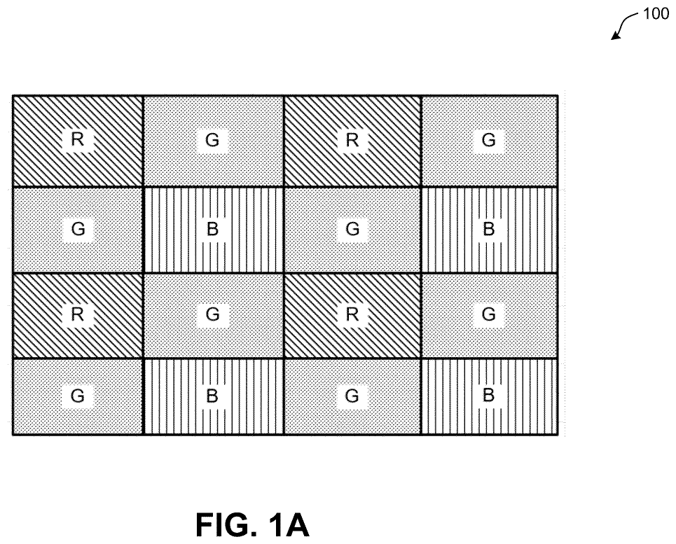

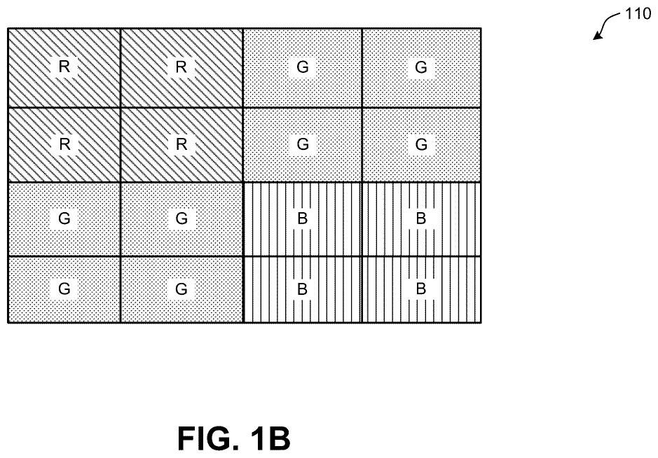

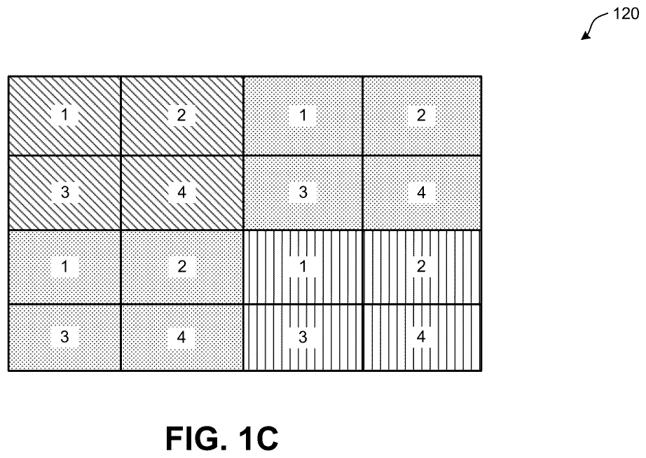

Various color filter arrays can be used, including a Bayer color filter array, a quad color filter array (also referred to as a quad Bayer filter or QCFA), and/or other color filter array. An example of a Bayer color filter array 100 is shown in FIG. 1A. As shown, the Bayer color filter array 100 includes a repeating pattern of red color filters, blue color filters, and green color filters. As shown in FIG. 1B, a QCFA 110 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the QCFA 110 shown in FIG. 1B is repeated for the entire array of photodiodes of a given image sensor. Using either QCFA 110 or the Bayer color filter array 100, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. The different photodiodes throughout the pixel array can have different spectral sensitivity curves, therefore responding to different wavelengths of light. Monochrome image sensors may also lack color filters and therefore lack color depth.

In some cases, subgroups of multiple adjacent photodiodes (e.g., 2×2 patches of photodiodes when QCFA 110 shown in FIG. 1B is used) can measure the same color of light for approximately the same region of a scene. For example, when photodiodes included in each of the subgroups of photodiodes are in close physical proximity, the light incident on each photodiode of a subgroup can originate from approximately the same location in a scene (e.g., a portion of a leaf on a tree, a small section of sky, etc.).

In some examples, a brightness range of light from a scene may significantly exceed the brightness levels that the image sensor can capture. For example, a digital single-lens reflex (DSLR) camera may be able to capture a 1:30,000 contrast ratio of light from a scene while the brightness levels of an HDR scene can exceed a 1:1,000,000 contrast ratio.

In some cases, HDR sensors may be utilized to enhance the contrast ratio of an image captured by an image capture device. In some examples, HDR sensors may be used to obtain multiple exposures within one image or frame, where such multiple exposures can include short (e.g., 5 ms) and long (e.g., 15 or more ms) exposure times. As used herein, a long exposure time generally refers to any exposure time that is longer than a short exposure time.

In some implementations, HDR sensors may be able to configure individual photodiodes within subgroups of photodiodes (e.g., the four individual R photodiodes, the four individual B photodiodes, and the four individual G photodiodes from each of the two 2×2 G patches in the QCFA 110 shown in FIG. 1B) to have different exposure settings. A collection of photodiodes with matching exposure settings is also referred to as photodiode exposure group herein. FIG. 1C illustrates a portion of an image sensor array with a QCFA filter that is configured with four different photodiode exposure groups 1 through 4. As shown in the example photodiode exposure group array 120 in FIG. 1C, each 2×2 patch can include a photodiode from each of the different photodiode exposure groups for a particular image sensor. Although four groupings are shown in a specific grouping in FIG. 1C, a person of ordinary skill will recognize that different numbers of photodiode exposure groups, different arrangements of photodiode exposure groups within subgroups, and any combination thereof can be used without departing from the scope of the present disclosure.

As noted with respect to FIG. 1C, in some HDR image sensor implementations, exposure settings corresponding to different photodiode exposure groups can include different exposure times (also referred to as exposure lengths), such as short exposure, medium exposure, and long exposure. In some cases, different images of a scene associated with different exposure settings can be formed from the light captured by the photodiodes of each photodiode exposure group. For example, a first image can be formed from the light captured by photodiodes of photodiode exposure group 1, a second image can be formed from the photodiodes of photodiode exposure group 2, a third image can be formed from the light captured by photodiodes of photodiode exposure group 3, and a fourth image can be formed from the light captured by photodiodes of photodiode exposure group 4. Based on the differences in the exposure settings corresponding to each group, the brightness of objects in the scene captured by the image sensor can differ in each image. For example, well-illuminated objects captured by a photodiode with a long exposure setting may appear saturated (e.g., completely white). In some cases, an image processor can select between pixels of the images corresponding to different exposure settings to form a combined image.

In one illustrative example, the first image corresponds to a short exposure time (also referred to as a short exposure image), the second image corresponds to a medium exposure time (also referred to as a medium exposure image), and the third and fourth images correspond to a long exposure time (also referred to as long exposure images). In such an example, pixels of the combined image corresponding to portions of a scene that have low illumination (e.g., portions of a scene that are in a shadow) can be selected from a long exposure image (e.g., the third image or the fourth image). Similarly, pixels of the combined image corresponding to portions of a scene that have high illumination (e.g., portions of a scene that are in direct sunlight) can be selected from a short exposure image (e.g., the first image.

In some cases, an image sensor can also utilize photodiode exposure groups to capture objects in motion without blur. The length of the exposure time of a photodiode group can correspond to the distance that an object in a scene moves during the exposure time. If light from an object in motion is captured by photodiodes corresponding to multiple image pixels during the exposure time, the object in motion can appear to blur across the multiple image pixels (also referred to as motion blur). In some implementations, motion blur can be reduced by configuring one or more photodiode groups with short exposure times. In some implementations, an image capture device (e.g., a camera) can determine local amounts of motion (e.g., motion gradients) within a scene by comparing the locations of objects between two consecutively captured images. For example, motion can be detected in preview images captured by the image capture device to provide a preview function to a user on a display. In some cases, a machine learning model can be trained to detect localized motion between consecutive images.

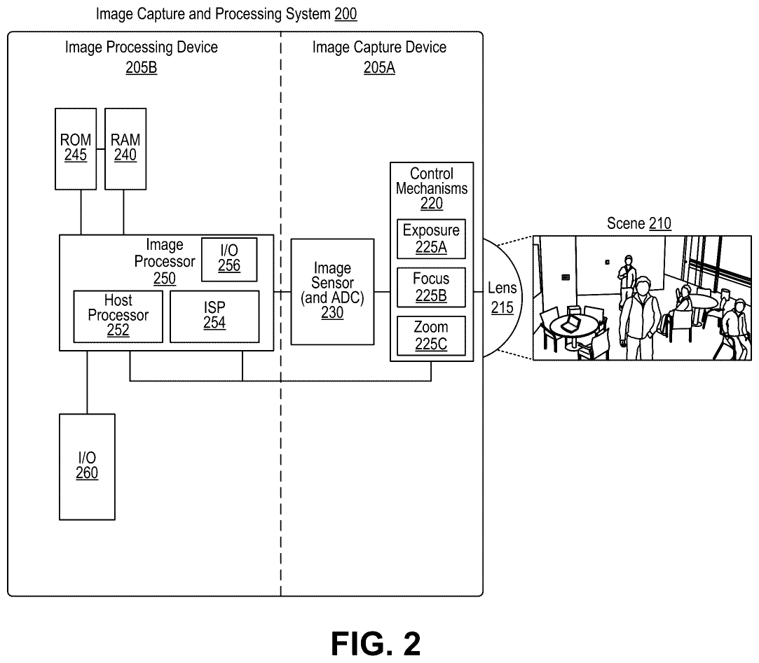

Various aspects of the techniques described herein will be discussed below with respect to the figures. FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. In some cases, the lens 215 and image sensor 230 can be associated with an optical axis. In one illustrative example, the photosensitive area of the image sensor 230 (e.g., the photodiodes) and the lens 215 can both be centered on the optical axis. A lens 215 of the image capture and processing system 200 faces a scene 210 and receives light from the scene 210. The lens 215 bends incoming light from the scene toward the image sensor 230. The light received by the lens 215 passes through an aperture. In some cases, the aperture (e.g., the aperture size) is controlled by one or more control mechanisms 220 and is received by an image sensor 230. In some cases, the aperture can have a fixed size.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo (or other lens mechanism), thereby adjusting focus. In some cases, additional lenses may be included in the image capture and processing system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 220, the image sensor 230, and/or the image processor 250. The focus setting may be referred to as an image capture setting and/or an image processing setting. In some cases, the lens 215 can be fixed relative to the image sensor and focus control mechanism 225B can be omitted without departing from the scope of the present disclosure.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 225C moves one or more of the lenses in the afocal zoom system, such as the negative lens and one or both of the positive lenses. In some cases, zoom control mechanism 225C can control the zoom by capturing an image from an image sensor of a plurality of image sensors (e.g., including image sensor 230) with a zoom corresponding to the zoom setting. For example, image capture and processing system 200 can include a wide angle image sensor with a relatively low zoom and a telephoto image sensor with a greater zoom. In some cases, based on the selected zoom setting, the zoom control mechanism 225C can capture images from a corresponding sensor.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different filters. In some cases, different photodiodes can be covered in color filters, and may thus measure light matching the color of the filter covering the photodiode. Various color filter arrays can be used, including a Bayer color filter array (as shown in FIG. 1A), a QCFA (see FIG. 1B), and/or any other color filter array.

Returning to FIG. 1A and FIG. 1B, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 230) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 230 may alternately or additionally include opaque and/or reflective masks that block light from reaching certain photodiodes, or portions of certain photodiodes, at certain times and/or from certain angles. In some cases, opaque and/or reflective masks may be used for PDAF. In some cases, the opaque and/or reflective masks may be used to block portions of the electromagnetic spectrum from reaching the photodiodes of the image sensor (e.g., an IR cut filter, an ultraviolet (UV) cut filter, a band-pass filter, low-pass filter, high-pass filter, or the like). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

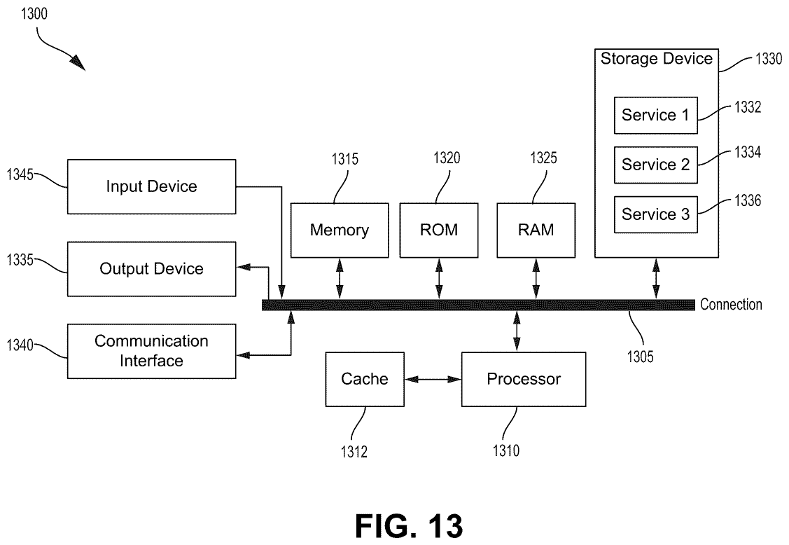

The image processor 250 may include one or more processors, such as one or more ISPs (e.g., ISP 254), one or more host processors (e.g., host processor 252), and/or one or more of any other type of processor 1310 discussed with respect to the computing system 1300 of FIG. 13. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240, read-only memory (ROM) 245, a cache, a memory unit, another storage device, or some combination thereof.

Various I/O devices 260 may be connected to the image processor 250. The I/O devices 260 can include a display screen, a keyboard, a keypad, a touchscreen, a trackpad, a touch-sensitive surface, a printer, any other output devices 1335, any other input devices 1345, or some combination thereof. In some cases, a caption may be input into the image processing device 205B through a physical keyboard or keypad of the I/O devices 260, or through a virtual keyboard or keypad of a touchscreen of the I/O devices 260. The I/O devices 260 may include one or more ports, jacks, or other connectors that enable a wired connection between the image capture and processing system 200 and one or more peripheral devices, over which the image capture and processing system 200 may receive data from the one or more peripheral device and/or transmit data to the one or more peripheral devices. The I/O devices 260 may include one or more wireless transceivers that enable a wireless connection between the image capture and processing system 200 and one or more peripheral devices, over which the image capture and processing system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O devices 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

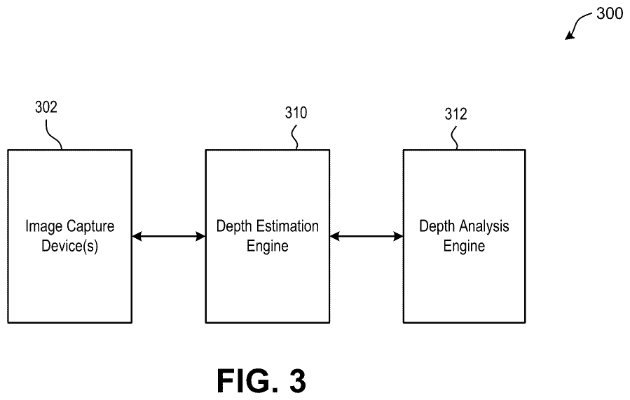

FIG. 3 is a block diagram illustrating an example of an image capture system 300. The image capture system 300 includes various components that are used to process input images or frames to produce an output image or frame. As shown, the components of the image capture system 300 include one or more image capture devices 302, a depth estimation engine 310, and a depth analysis engine 312. The image capture devices 302 can produce an image of a scene and the depth analysis engine 312 can detect the depth of the content in the scene, as described in more detail herein. In some aspects, the depth estimation engine 310 can use an image stream from a monocular image sensor (as an example of one of the image capture devices 302) to identify depth information of the content in the scene.

The image capture system 300 can include or be part of an electronic device or system. For example, the image capture system 300 can include or be part of an electronic device or system, such as a mobile or stationary telephone handset (e.g., smartphone, cellular telephone, or the like), an extended reality (XR) device (e.g., a virtual reality (VR) device, an augmented reality (AR) device, or a mixed reality (MR) device), a vehicle or computing device/system of a vehicle, a server computer (e.g., in communication with another device or system, such as a mobile device, an XR system/device, a vehicle computing system/device, etc.), a desktop computer, a laptop or notebook computer, a tablet computer, a set-top box, a television, a camera device, a display device, a digital media player, a video streaming device, or any other suitable electronic device. In some examples, the image capture system 300 can include one or more wireless transceivers (or separate wireless receivers and transmitters) for wireless communications, such as cellular network communications, 802.11 Wi-Fi communications, WLAN communications, Bluetooth or other short-range communications, any combination thereof, and/or other communications. In some implementations, the components of the image capture system 300 can be part of the same computing device. In some implementations, the components of the image capture system 300 can be part of two or more separate computing devices.

While the image capture system 300 is shown to include certain components, one of ordinary skill will appreciate that image capture system 300 can include more components or fewer components than those shown in FIG. 3. In some cases, additional components of the image capture system 300 can include software, hardware, or one or more combinations of software and hardware. For example, in some cases, the image capture system 300 can include one or more other sensors (e.g., one or more inertial measurement units (IMUs), radars, light detection and ranging (LIDAR) sensors, audio sensors, etc.), one or more display devices, one or more other processing engines, one or more other hardware components, and/or one or more other software and/or hardware components that are not shown in FIG. 3. In some implementations, additional components of the image capture system 300 can include and/or can be implemented using electronic circuits or other electronic hardware, which can include one or more programmable electronic circuits (e.g., DSPs, microprocessors, microcontrollers, GPUs, CPUs, any combination thereof, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture system 300.

The image capture device 302 can be a monocular image system capture image data and generate images (or frames) based on the image data and/or can provide the image data to the depth estimation engine 310 to generate depth information. The depth estimation engine 310 may provide the depth information to a depth analysis engine 312 to analyzes the depths for various purposes. For example, the depth analysis engine 312 may be included in an autonomous navigation system for an autonomous vehicle. The depth analysis engine 312 may be implemented in functions that can benefit from understanding the distance from the image capture devices 302 to the objects within the scene, and identify various aspects of the scene. For example, the depth analysis engine 312 may be configured to identify movement of an object within the scene. In some cases, the depth analysis engine 312 may be use the depth information to classify objects within the scene. For example, the depth analysis engine 312 may be used to distinguish between a biological moving object and a non-biological moving object.

The one or more image capture devices 302 can also provide the image data to an output device for output (e.g., on a display). In some cases, the output device can also include storage. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image. In addition to image data, the image capture devices can also generate supplemental information such as the amount of time between successively captured images, timestamps of image capture, or the like.

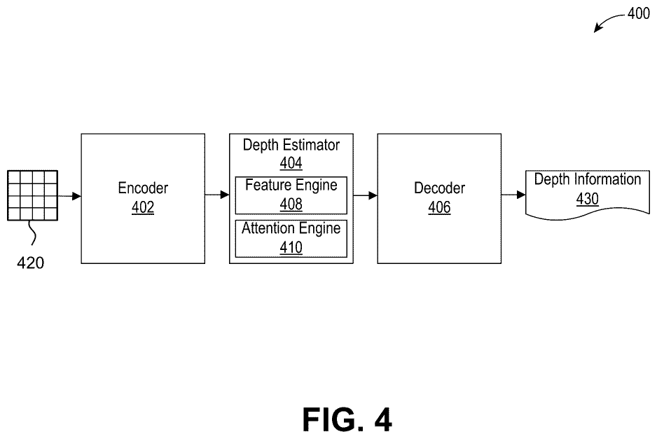

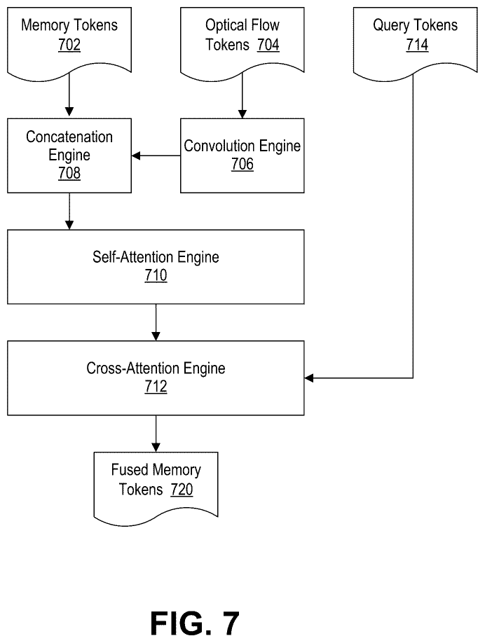

FIG. 4 is a block diagram of an image capture system 400 that uses attention to estimate depth information, in accordance with some aspects of the disclosure. In some aspects, the image capture system 400 includes an encoder 402, a depth estimator 404, and a decoder 406. The depth estimator 404 includes a feature engine 408 and an attention engine 410 configured to identify features and identify objects that require attention to understand the scene. In some aspects, attention may also be at least one region of interest that provides important cues about the scene. Attention is related to transformer functions (e.g., natural language processing (NLP) transformer functions) that identify important words that provide important cues about the language. In some aspects, the attention engine 410 may include a self-attention analysis and a cross-attention analysis that will be described below in FIG. 7. In a conventional NLP transformer, attention uses information from an encoder or a decoder and provides that information to the corresponding decoder or encoder to improve various processing.

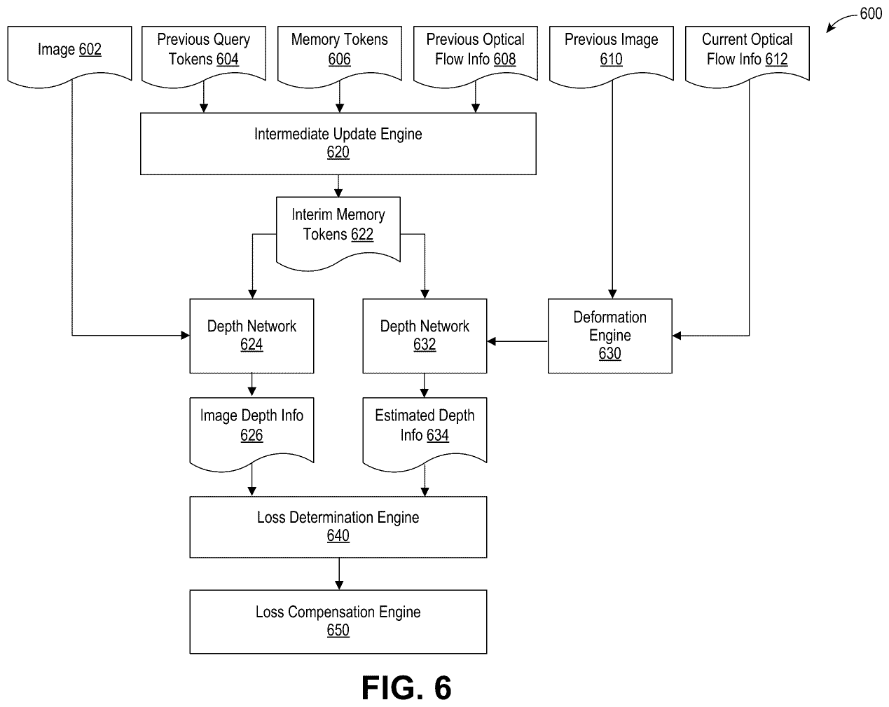

A stream of images 420 may be provided by a monocular imaging system (e.g., the image capture devices 302) at a frame rate (e.g., 30 Hz, 60 Hz, etc.) and each image is encoded in the encoder 402. In some aspects, the encoder 402 is configured to identify features in each image, and the features are often referred to as vectors or tokens. In one aspect, the encoder 402 represents the image as query tokens, which are potential features of interest in the scene. As described in FIG. 6, the query tokens are provided to the depth estimator 404 and features within the query tokens are identified by the feature engine 408. In some aspects, the decoder 406 includes memory tokens, which are tokens that identify relevant features within the scene and are stored for use in connection with later images. In some cases, the memory tokens may be referred to as accumulated query information and represent relevant features of previous images. The feature engine 408 is configured to update and maintain the memory tokens based on the image 420. The memory tokens summarize and store key past information as features and the depth estimator 404 can cross-reference relevant features from previous frames when inferring depth on the image 420. The depth estimator 404 updates the memory tokens each image and stores the most relevant information.

The decoder 406 is configured to use the memory tokens and the query tokens from the encoder 402 and infer depth information 430. In some aspects, the decoder 406 converts the query tokens into distance information that identifies a distance to objects within the scene. For example, the depth information may be represented by an image with each pixel corresponding to a distance from the monocular imaging system (e.g., the image capture devices 302) to the object in the scene. In some aspects, the decoder 406 may also be configured to generate optical flow information of the image 420 that identifies motion in the from a previous image to the image 420. For example, the optical flow information may be based on motion of the image capture system 400 within the environment or motion of objects within the environment.

In some aspects, the image capture system 400 is configured to identify depth using the memory tokens and fusing the memory tokens with the query tokens of the input image. The image capture system 400 is able to stream depth information without any delay and reduces computation complexity by combining attention to identify temporal relationships.

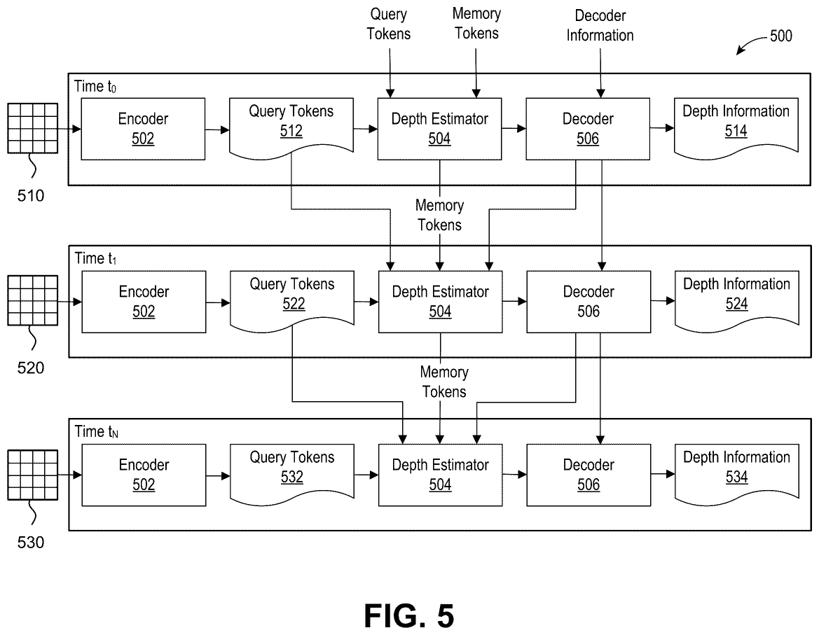

FIG. 5 is a conceptual diagram of operation of an image capture system 500 to estimating depth information using attention, in accordance with some aspects of the disclosure. In some aspect, the image capture system 500 includes an encoder 502 (e.g., the encoder 402), a depth estimator 504 (e.g., the depth estimator 404), and a decoder 506 (e.g., the decoder 406) that receives a plurality of images and converts the images into depth information. For example, the image capture system 500 is presumed to be operating prior to time to and receives a first image 510. The encoder 502 encodes the first image 510 into query tokens 512 (e.g., feature information) that represent various features of the image 510.

During the time to interval, the query tokens 512 are provided to the depth estimator 504 to update memory tokens, at time to. In some aspects, the memory tokens are relevant query tokens from previous images prior to time to. The memory tokens may also be referred to as accumulated feature information or accumulated query tokens and represent a set of informative tokens derived from previous frames. As further described below, the memory tokens may also include optical flow information from the previous frames.

The depth estimator 504 also receives previous query tokens of a prior image and optical flow information of the prior image. The memory tokens are updated based on the query tokens 512 of the image 510, the previous query tokens, and the optical flow information from the previous image. For example, the depth estimator 504 may identify available query tokens in the query tokens 512 tokens that are also present in the query tokens 512 and update the memory tokens. In some cases, the memory update prunes query tokens in the accumulated query tokens that are not material to the scene depicted in the image 510. The updating of the accumulated feature information is described in more detail in FIG. 7.

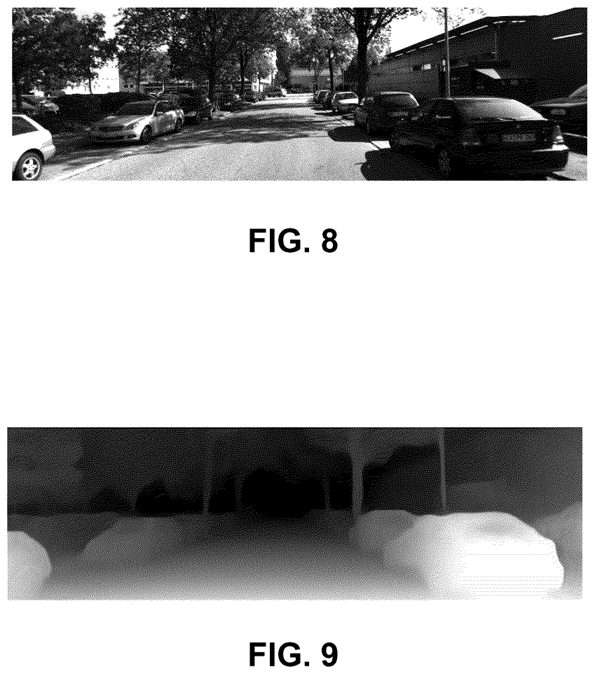

In some aspects, the depth estimator 504 may identify available memory tokens from the memory tokens that are present within the query tokens, and then learn a temporal relationship between the available memory tokens and the query tokens 512. In some aspects, the learning of the temporal relationship may be based on attention and will be described in further detail in FIG. 8. The memory tokens from the depth estimator 504 are provided to the decoder 506 and generate depth information 514 associated with the image 510. The decoder 506 also generates an optical flow information associated with the image 510 and provides the optical flow information to the depth estimator 504. In some aspects, the operations of linear combination in the convolution engine generate an approximation of the relative motion between the current time and each previous time step, which generates optical flow information without an explicit optical flow computation.

In a next interval (e.g., a next frame from the image capture devices 302) at time ti, a second image 520 is provided to the encoder 502 and the encoder 502 encodes the second image 520 into query tokens 522. The depth estimator 504 receives the query tokens 522 and the query tokens 512 from time ti and the memory tokens. In some cases, the image capture system 500 may also receive optical flow information associated with a previous frame (e.g., the image 510) from the decoder 506. The depth estimator 504 performs the memory update and attention as described above to update the memory tokens based on the query tokens 512 and 522. The decoder 506 uses the memory tokens to infer depth of the features in the query tokens 522 using an ML model and obtain depth information 524.

The image capture system 500 operates until a last image 530 is provided to the image capture system 500 at time t_{N}, at which point the image capture system 500 encodes the last image 530 into query tokens 532 and then generates the depth information 534.

In some aspects, the decoder information may be provided to the decoder 506, which can include optical flow information and other previous decoder features. In some aspects, the additional decoder information provided between decoding iterations of the decoder 506 may improve accuracy.

FIG. 6 is a conceptual diagram of a feature detection engine 600 of a depth estimator, in accordance with some aspects of the disclosure. The feature detection engine 600 is configured to use an input image 602 (e.g., the second image 520 in FIG. 5), previous query token of a prior frame (e.g., the query tokens 512 generated from encoding the first image 510), memory tokens 606, previous optical flow information 608, a previous image (e.g., the first image 510), and current optical flow information 612 to perform an intermediate update on the memory tokens via an intermediate update engine 620.

In some aspects, the memory tokens may include query tokens associated with features in the query tokens and optical flow tokens that identify optical flow. The memory tokens may be represented as Mₜ={Mₜ^{V}, Mₜ^{P}}. In this case, Mt is a tuple with Mₜ^{V} corresponding to the accumulated query tokens from previous images and MP corresponding to optical flow tokens from previous frames. The intermediate update engine 620 is configured to update the memory tokens by concatenating the previous query tokens 604 of the prior image and the previous optical flow information 608 onto the memory tokens 606 and generate interim memory tokens 622, which are represented as [symbol] . In this case, [symbol] ={ [symbol] , [symbol] ]} with [symbol] ={M, Qₜ₋₁} and [symbol] ={M, Oₜ₋₁}. The previous query tokens 604 are represented by Qₜ₋₁ and the previous optical flow information 608 is represented by Oₜ₋₁.

The query tokens of the interim memory tokens 622, or [symbol] , and the image 602 are input into a depth network 624 to generate image depth information 626 of the image 602, or [symbol] . In this case, the image depth information 626 is an inference of the current frame based on the interim memory tokens 622. For example, the depth network 624 may include at least one cross-attention layer configured to generate the image depth information 626 based on the image 602 and the interim memory tokens 622.

In some aspects, the feature detection engine 600 uses optical flow information and a previous image to generate an estimated depth of the scene, which can be used to identify a loss to correct errors. One technique to generate the estimated depth scene includes deforming the previous image based on the optical flow. For example, the previous image 610 and the current optical flow information 612 are input into a deformation engine 630 to modify the previous image 610 based on the current optical flow information 612 and create an estimated image. The estimated image is input into a depth network 632 with the corresponding memory tokens of the interim memory tokens 622, or [symbol] , to generate the estimated depth information 634. For example, the depth network 632 may include at least one cross-attention layer configured to generate the estimated depth information 634 based on the estimated image from the deformation engine 630 and the interim memory tokens 622.

The image depth information 626 and the estimated depth information 634 are provided to a loss determination engine 640 to determine a loss and gradients of the image depth information 626 and the estimated depth information 634. In one illustrative aspect, the loss is computed based on the difference between the image depth information 626 and the estimated depth information 634 using a scale-invariant logarithmic (SILog) loss function. The loss of the image depth information 626 may be represented as ∇ [symbol] and the loss of the estimated depth information 634 may be represented as ∇ [symbol] .

In some aspects, the losses determined by the loss determination engine 740 are provided to a loss compensation engine 650. The loss compensation engine 650 combines the interim memory tokens with the losses and generates memory tokens for the next image. For example, the loss compensation engine 650 may backpropagate the losses into a depth estimation network to correct for losses that are measured by the loss determination engine 640. The loss compensation engine 650 generates memory tokens Mₜ₊₁ for the next frame by fusing the interim memory tokens [symbol] with the corresponding losses. For example, Mₜ₊₁ is a tuple of the accumulated query tokens Mₜ₊₁^{V} and optical flow tokens Mₜ₊₁^{P}, with the Mₜ₊₁^{V}= [symbol] −∇ [symbol] and Mₜ₊₁^{P}= [symbol] −∇ [symbol] .

In some aspects, the feature detection engine 600 is configured to update the memory tokens by removing irrelevant information that existed in previous input images and storing the useful features of recent images. In some aspects, the memory tokens allow the feature detection engine 600 to cross-reference relevant features from previous frames when inferring depth on the current input frame.

FIG. 7 is a conceptual diagram of an attention engine, in accordance with some aspects of the disclosure. In some aspects, the attention engine 700 uses the memory tokens generated by the feature detection engine 600 to fuse features in the query tokens associated with the current image with the memory tokens. For example, the memory tokens Mₜ include the accumulated query tokens 702 and the optical flow tokens 704 to perform attention to learn temporal relationships.

In the illustrated aspect, the optical flow tokens 704 provided to a convolution engine 706 to learn the number of positional encodings in the optical flow tokens 704. The positional encoding identifies a temporal relationship between the optical flow tokens and can be used to identify temporal relationships within the memory tokens by using attention. In some aspects, the operations of linear combination in the convolution engine 706 learn an approximation of the relative motion between the current time and each previous time step, which generates optical flow information without an explicit optical flow computation.

The positional encodings from the convolution engine 706 and the accumulated query tokens 702 are provided to a concatenation engine 708, which concatenates the accumulated query tokens 702 with the positional encodings. The concatenated tokens are provided to a self-attention function 710 to learn the relationship between the query tokens and corresponding positional encodings.

The query tokens from the self-attention engine are then provided to a cross-attention engine 712 to fuse the memory tokens with the query tokens 714 of the current image to generate fused memory tokens 720. The memory tokens serve as the queries in the cross-attention engine 712 and learn the temporal inference. The memory tokens can be fused with the query tokens and results in the fused memory tokens 720. The fused memory tokens 720 may then be provided to the decoder, which decodes the fused memory tokens 720 into depth information.

FIG. 8 is an image captured by an image capture system, in accordance with some aspects of the disclosure. In some aspects, the image capture system may be mounted to an autonomous vehicle for navigating the environment and need to understand the position of objects within the environment.

FIG. 9 is an illustration of depth information determined by an image capture system, in accordance with some aspects of the disclosure. Colors in FIG. 9 represent a distance to the objects within the scene in FIG. 8 and may be used to identify objects and navigate the environment using a monocular imaging system.

In some aspects, training of one or more of the machine learning systems, models, or networks described herein (e.g., such as the encoder 402, the depth estimator 404, and/or the decoder 406 of the image capture system 400 of FIG. 4, the encoder 502, the depth estimator 504, and/or the decoder 506 of the image capture system 500 of FIG. 5, feature detection engine 600 of FIG. 6, among various other machine learning systems, models, or networks described herein, etc.) can be performed using online training, offline training, and/or various combinations of online and offline training. In some cases, online may refer to time periods during which the input data (e.g., the images 420 of FIG. 4, one or more of the images 510, 520, 530 of FIG. 5, etc.) is processed, for instance for performance of the depth estimation implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others.

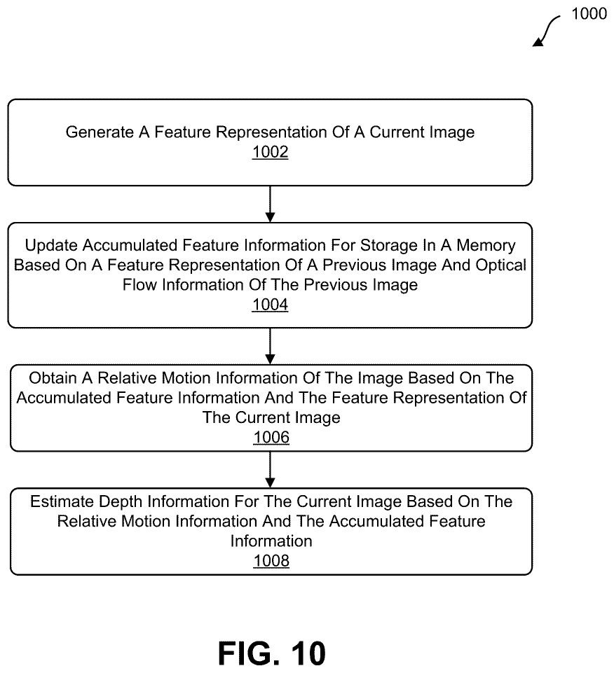

FIG. 10 is a flowchart illustrating an example process 1000 for capturing images using a monocular image sensor and detecting depth information in accordance with aspects of the present disclosure. The process 1000 can be performed by a computing device having an image sensor, such as a mobile wireless communication device, a vehicle (e.g., an autonomous or semi-autonomous vehicle, a wireless-enabled vehicle, and/or other type of vehicle) or computing device or system of the vehicle, a CV robot function (e.g., manufacturing), a camera, an XR device, or another computing device. In one illustrative example, a computing system (e.g., computing system 1300) can be configured to perform all or part of the process 1000. In one illustrative example, the image capture system 400 and/or the image capture system 500 can be configured to perform all or part of the process 1000. For instance, the computing system 1300 may include the components of the system 400 and/or 500 and can be configured to perform all or part of the process 1000. In another illustrative example, an ISP such as the ISP 254 can be configured to perform all or part of the process 1000.

Although the example process 1000 depicts a particular sequence of operations, the sequence may be altered without departing from the scope of the present disclosure. For example, some of the operations depicted may be performed in parallel or in a different sequence that does not materially affect the function of the process 1000. In other examples, different components of an example device or system that implements the process 1000 may perform functions at substantially the same time or in a specific sequence.

At block 1002, a computing system (e.g., the computing system 1300) may obtain an image and generate a feature representation of a current image. In some aspects, a single image sensor obtains the current image. The feature representation may be a query token, and may have varying names such as a vector or an embedding that represents the feature.

At block 1004, the computing system may update accumulated feature information for storage in a memory based on a feature representation of a previous image and optical flow information of the previous image. For example, the accumulated feature information may include memory tokens that are identified from query tokens in previous images. The accumulated feature information comprises accumulated image feature information associated with a plurality of previous images and accumulated optical flow information associated of the plurality of previous images. For instance, the accumulated feature tokens are configured to store relevant information from previous images and discard information that becomes immaterial due to motion.

In some aspects, the updating accumulated feature information by the computing system may include modifying the previous image based on the optical flow information to obtain an estimated image. For example, a previous image can be modified by the optical flow based on distorting the image based on the optical flow information.

In some aspects, the computing system may also obtain first depth information and second depth information. In one illustrative example, the computing system may obtain the first depth information based on the accumulated image feature information associated with the plurality of previous images and the current image. In another example, the computing system may obtain second depth information based on the accumulated optical flow information associated of the plurality of previous images and the estimated image.

In some aspects, the computing system may determine a loss based on the first depth information and the second depth information. In one aspect, the loss is determined based on a difference between the first depth information and the second depth information. The accumulated feature information is updated based on the loss.

At block 1006, the computing system may obtain information associated with relative motion of the current image based on the accumulated feature information and the feature representation of the current image.

In some aspects, to obtain information associated with relative motion, the computing may convolute the accumulated optical flow information associated of the plurality of previous images to learn positional encodings of features in the accumulated image feature information associated with the plurality of previous images. For example, the accumulated optical flow information is provided to a convolution engine that identifies features within the image.

The computing system may perform a self-attention on the accumulated image feature information and the positional encodings to identify temporal information. In one aspect, the temporal information corresponds to a temporal relationship of features within the accumulated feature information. In some aspects, the computing system may perform a cross-attention based on the temporal information and the feature representation of the current image to identify the relative motion.

At block 1008, the computing system may estimate depth information for the current image based on the information associated with the relative motion and the accumulated feature information. Estimating the depth information for the current image comprises estimating a respective depth for each region of the current image. For example, each region of the current image comprises a respective pixel of the current image. In another example, each region may be a group of respective pixels.

In some aspects, the computing system may update accumulated decoder information based on the accumulated feature information and a previous optical flow information associated with the previous image. Estimating the depth information for the current image is further based on the accumulated decoder information and the optical flow information.

In some examples, the processes described herein (e.g., process 1000, and/or other process described herein) may be performed by a computing device or apparatus. In one example, the process 1000 can be performed by a computing device (e.g., image capture and processing system 200 in FIG. 2) having a computing architecture of the computing system 1300 shown in FIG. 13.

The process 1000 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The process 1000, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

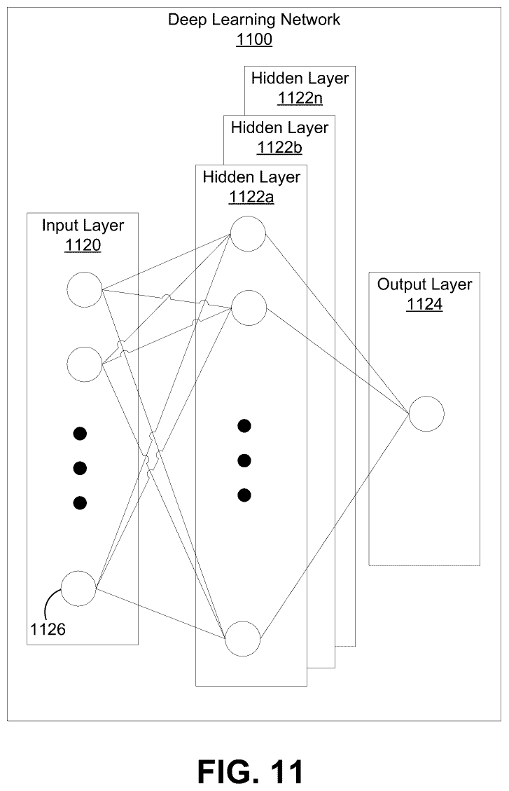

As noted above, various aspects of the present disclosure can use machine learning models or systems. FIG. 11 is an illustrative example of a deep learning neural network 1100 that can be used to implement the machine learning based alignment prediction described above. An input layer 1120 includes input data. In one illustrative example, the input layer 1120 can include data representing the pixels of an input video frame. The neural network 1100 includes multiple hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The neural network 1100 further includes an output layer 1121 that provides an output resulting from the processing performed by the hidden layers 1122a, 1122b, through 1122n. In one illustrative example, the output layer 1121 can provide a classification for an object in an input video frame. The classification can include a class identifying the type of activity (e.g., looking up, looking down, closing eyes, yawning, etc.).

The neural network 1100 is a multi-layer neural network of interconnected nodes. Each node can represent a piece of information. Information associated with the nodes is shared among the different layers and each layer retains information as information is processed. In some cases, the neural network 1100 can include a feed-forward network, in which case there are no feedback connections where outputs of the network are fed back into itself. In some cases, the neural network 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the first hidden layer 1122a can transform the information of each input node by applying activation functions to the input node information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1121, at which an output is provided. In some cases, while nodes (e.g., node 1126) in the neural network 1100 are shown as having multiple output lines, a node has a single output and all lines shown as being output from a node represent the same output value.

In some cases, each node or interconnection between nodes can have a weight that is a set of parameters derived from the training of the neural network 1100. Once the neural network 1100 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1100 to be adaptive to inputs and able to learn as more and more data is processed.

The neural network 1100 is pre-trained to process the features from the data in the input layer 1120 using the different hidden layers 1122a, 1122b, through 1122n in order to provide the output through the output layer 1121. In an example in which the neural network 1100 is used to identify features and/or objects in images, the neural network 1100 can be trained using training data that includes both images and labels, as described above. For instance, training images can be input into the network, with each training frame having a label indicating the features in the images (for a feature extraction machine learning system) or a label indicating classes of an activity in each frame. In one example using object classification for illustrative purposes, a training frame can include an image of a number 2, in which case the label for the image can be [0 0 1 0 0 0 0 00 0].

In some cases, the neural network 1100 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 1100 is trained well enough so that the weights of the layers are accurately tuned.

For the example of identifying features and/or objects in images, the forward pass can include passing a training image through the neural network 1100. The weights are initially randomized before the neural network 1100 is trained. As an illustrative example, a frame can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 1100, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1100 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1100 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{dW} ,$$

where w denotes a weight, wᵢ denotes the initial weight, and f denotes a learning rate. The learning rate can be set to any suitable value, with a high learning rate including larger weight updates and a lower value indicating smaller weight updates.

The neural network 1100 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1100 can include any other deep network other than a CNN, such as an autoencoder, a deep belief nets (DBNs), a Recurrent Neural Networks (RNNs), among others.

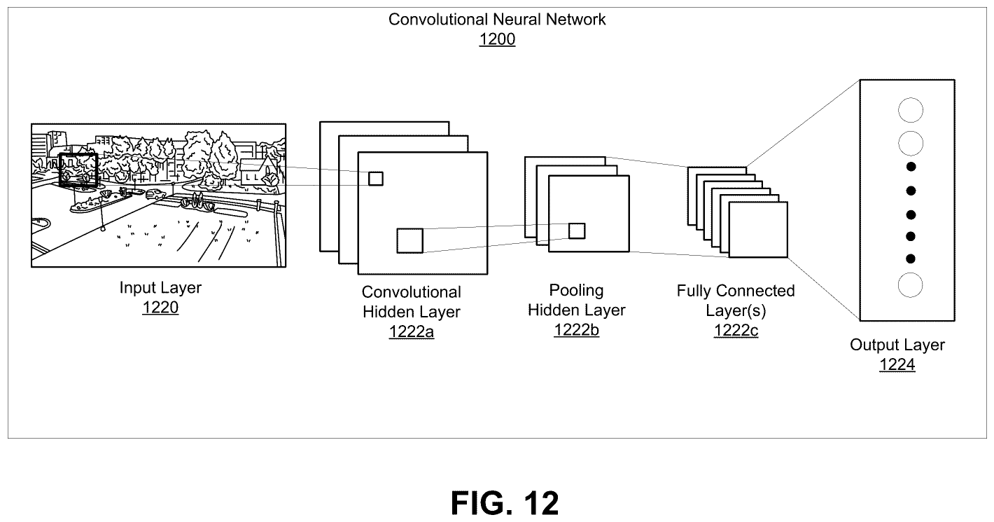

FIG. 12 is an illustrative example of a CNN 1200. The input layer 1220 of the CNN 1200 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1222a, an optional non-linear activation layer, a pooling hidden layer 1222b, and fully connected hidden layers 1222c to get an output at the output layer 1224. While only one of each hidden layer is shown in FIG. 12, one of ordinary skill will appreciate that multiple convolutional hidden layers, non-linear layers, pooling hidden layers, and/or fully connected layers can be included in the CNN 1200. As previously described, the output can indicate a single class of an object or can include a probability of classes that best describe the object in the image.

The first layer of the CNN 1200 is the convolutional hidden layer 1222a. The convolutional hidden layer 1222a analyzes the image data of the input layer 1220. Each node of the convolutional hidden layer 1222a is connected to a region of nodes (pixels) of the input image called a receptive field. The convolutional hidden layer 1222a can be considered as one or more filters (each filter corresponding to a different activation or feature map), with each convolutional iteration of a filter being a node or neuron of the convolutional hidden layer 1222a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1222a. Each connection between a node and a receptive field for that node learns a weight and, in some cases, an overall bias such that each node learns to analyze its particular local receptive field in the input image. Each node of the hidden layer 1222a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1222a is due to each node of the convolutional layer being applied to its corresponding receptive field. For example, a filter of the convolutional hidden layer 1222a can begin in the top-left corner of the input image array and can convolve around the input image. As noted above, each convolutional iteration of the filter can be considered a node or neuron of the convolutional hidden layer 1222a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1222a. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1222a.

The mapping from the input layer to the convolutional hidden layer 1222a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1222a can include several activation maps in order to identify multiple features in an image. The example shown in FIG. 12 includes three activation maps. Using three activation maps, the convolutional hidden layer 1222a can detect three different kinds of features, with each feature being detectable across the entire image.

In some examples, a non-linear hidden layer can be applied after the convolutional hidden layer 1222a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1200 without affecting the receptive fields of the convolutional hidden layer 1222a.

The pooling hidden layer 1222b can be applied after the convolutional hidden layer 1222a (and after the non-linear hidden layer when used). The pooling hidden layer 1222b is used to simplify the information in the output from the convolutional hidden layer 1222a. For example, the pooling hidden layer 1222b can take each activation map output from the convolutional hidden layer 1222a and generates a condensed activation map (or feature map) using a pooling function. Max-pooling is one example of a function performed by a pooling hidden layer. Other forms of pooling functions be used by the pooling hidden layer 1222a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1222a. In the example shown in FIG. 12, three pooling filters are used for the three activation maps in the convolutional hidden layer 1222a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1222a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1222a having a dimension of 24×24 nodes, the output from the pooling hidden layer 1222b will be an array of 18×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1200.

The final layer of connections in the network is a fully-connected layer that connects every node from the pooling hidden layer 1222b to every one of the output nodes in the output layer 1224. Using the example above, the input layer includes 28×28 nodes encoding the pixel intensities of the input image, the convolutional hidden layer 1222a includes 3×24×24 hidden feature nodes based on application of a 5×5 local receptive field (for the filters) to three activation maps, and the pooling hidden layer 1222b includes a layer of 3×12×12 hidden feature nodes based on application of max-pooling filter to 2×2 regions across each of the three feature maps. Extending this example, the output layer 1224 can include ten output nodes. In such an example, every node of the 3×12×12 pooling hidden layer 1222b is connected to every node of the output layer 1224.

The fully connected layer 1222c can obtain the output of the previous pooling hidden layer 1222b (which should represent the activation maps of high-level features) and determines the features that most correlate to a particular class. For example, the fully connected layer 1222c layer can determine the high-level features that most strongly correlate to a particular class, and can include weights (nodes) for the high-level features. A product can be computed between the weights of the fully connected layer 1222c and the pooling hidden layer 1222b to obtain probabilities for the different classes. For example, if the CNN 1200 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1224 can include an M-dimensional vector (in the prior example, M=10). M indicates the number of classes that the CNN 1200 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 13 is a diagram illustrating an example of a system for implementing certain aspects of the present technology. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1300 includes at least one processing unit (CPU or processor) 1310 and connection 1305 that couples various system components including system memory 1315, such as ROM 1320 and RAM 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300. Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., process 1000, and/or other process described herein) may be performed by a computing device or apparatus. In one example, the process 1000 can be performed by a computing device (e.g., image capture and processing system 200 in FIG. 2) having a computing architecture of the computing system 1300 shown in FIG. 13.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11×) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the present disclosure include:

Aspect 1. A method of processing one or more images by an image capturing device, comprising: generating a feature representation of a current image; updating accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images; obtaining information associated with relative motion of the current image based on the accumulated feature information and the feature representation of the current image; and estimating depth information for the current image based on the information associated with the relative motion and the accumulated feature information.

Aspect 2. The method of Aspect 1, wherein a single image sensor obtains the current image.

Aspect 3. The method of any of Aspects 1 to 2, wherein estimating the depth information for the current image comprises estimating a respective depth for each region of the current image.

Aspect 4. The method of any of Aspects 1 to 3, wherein each region of the current image comprises a respective pixel of the current image.

Aspect 5. The method of any of Aspects 1 to 4, wherein updating the accumulated feature information comprises: modifying the previous image based on the optical flow information to obtain an estimated image; obtaining first depth information based on the accumulated image feature information associated with the plurality of previous images and the current image; and obtaining second depth information based on the accumulated optical flow information associated of the plurality of previous images and the estimated image.

Aspect 6. The method of any of Aspects 1 to 5, wherein updating the accumulated feature information comprises: determining a loss based on the first depth information and the second depth information, wherein the accumulated feature information is updated based on the loss.

Aspect 7. The method of any of Aspects 1 to 6, wherein the loss is determined based on a difference between the first depth information and the second depth information.

Aspect 8. The method of any of Aspects 1 to 7, wherein obtaining the information associated with the relative motion comprises: convoluting the accumulated optical flow information associated of the plurality of previous images to learn positional encodings of features in the accumulated image feature information associated with the plurality of previous images.

Aspect 9. The method of any of Aspects 1 to 8, further comprising: performing a self-attention on the accumulated image feature information and the positional encodings to identify temporal information, the temporal information corresponding a temporal relationship of features within the accumulated feature information.

Aspect 10. The method of any of Aspects 1 to 9, further comprising: performing a cross-attention based on the temporal information and the feature representation of the current image to identify the relative motion.

Aspect 11. The method of any of Aspects 1 to 10, further comprising: updating accumulated decoder information based on the accumulated feature information and a previous optical flow information associated with the previous image.

Aspect 12. The method of any of Aspects 1 to 11, wherein estimating the depth information for the current image is further based on the accumulated decoder information and the optical flow information.

Aspect 13. An apparatus for processing one or more images, the apparatus including one or more memories configured to store data associated with at least a current image and one or more processors coupled to the one or more memories and configured to: generate a feature representation of a current image; update accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images; obtain information associated with relative motion of the current image based on the accumulated feature information and the feature representation of the current image; and estimate depth information for the current image based on the information associated with the relative motion and the accumulated feature information.

Aspect 14. The apparatus of Aspect 13, further comprising a single image sensor configured to obtain the current image.

Aspect 15. The apparatus of any of Aspects 13 to 14, wherein, to estimate the depth information for the current image, the one or more processors are configured to estimate a respective depth for each region of the current image.

Aspect 16. The apparatus of any of Aspects 13 to 15, wherein each region of the current image comprises a respective pixel of the current image.

Aspect 17. The apparatus of any of Aspects 13 to 16, wherein the one or more processors are configured to: modify the previous image based on the optical flow information to obtain an estimated image; obtain first depth information based on the accumulated image feature information associated with the plurality of previous images and the current image; and obtain second depth information based on the accumulated optical flow information associated of the plurality of previous images and the estimated image.

Aspect 18. The apparatus of any of Aspects 13 to 17, wherein the one or more processors are configured to: determine a loss based on the first depth information and the second depth information, wherein the accumulated feature information is updated based on the loss.

Aspect 19. The apparatus of any of Aspects 13 to 18, wherein the one or more processors are configured to determine the loss based on a difference between the first depth information and the second depth information.

Aspect 20. The apparatus of any of Aspects 13 to 19, wherein the one or more processors are configured to: convolute the accumulated optical flow information associated of the plurality of previous images to learn positional encodings of features in the accumulated image feature information associated with the plurality of previous images.

Aspect 21. The apparatus of any of Aspects 13 to 20, wherein the one or more processors are configured to: perform a self-attention on the accumulated image feature information and the positional encodings to identify temporal information, the temporal information corresponding a temporal relationship of features within the accumulated feature information.

Aspect 22. The apparatus of any of Aspects 13 to 21, wherein the one or more processors are configured to: perform a cross-attention based on the temporal information and the feature representation of the current image to identify the relative motion.

Aspect 23. The apparatus of any of Aspects 13 to 22, wherein the one or more processors are configured to: update accumulated decoder information based on the accumulated feature information and a previous optical flow information associated with the previous image.

Aspect 24. The apparatus of any of Aspects 13 to 23, wherein the one or more processors are configured to estimate the depth information for the current image further based on the accumulated decoder information and the optical flow information.

Aspect 25. A non-transitory computer-readable medium having stored thereon instructions that, when executed by one or more processors, cause the one or more processors to perform operations according to any of Aspects 1 to 12.

Aspect 26. An apparatus for processing one or more images, comprising one or more means for performing operations according to any of Aspects 1 to 12.

What is claimed is:

1. An apparatus for processing one or more images, comprising:
one or more memories configured to store data associated with at least a current image; and
one or more processors coupled to the one or more memories and configured to:
generate a feature representation of the current image;
update accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images;
obtain information associated with relative motion of the current image based on the accumulated feature information and the feature representation of the current image; and
estimate depth information for the current image based on the information associated with the relative motion and the accumulated feature information.

2. The apparatus of claim 1, further comprising a single image sensor configured to obtain the current image.

3. The apparatus of claim 1, wherein, to estimate the depth information for the current image, the one or more processors are configured to estimate a respective depth for each region of the current image.

4. The apparatus of claim 2, wherein each region of the current image comprises a respective pixel of the current image.

5. The apparatus of claim 1, wherein the one or more processors are configured to:
modify the previous image based on the optical flow information to obtain an estimated image;
obtain first depth information based on the accumulated image feature information associated with the plurality of previous images and the current image; and
obtain second depth information based on the accumulated optical flow information associated of the plurality of previous images and the estimated image.

6. The apparatus of claim 5, wherein the one or more processors are configured to:
determine a loss based on the first depth information and the second depth information, wherein the accumulated feature information is updated based on the loss.

7. The apparatus of claim 6, wherein the one or more processors are configured to determine the loss based on a difference between the first depth information and the second depth information.

8. The apparatus of claim 1, wherein the one or more processors are configured to:
convolute the accumulated optical flow information associated of the plurality of previous images to learn positional encodings of features in the accumulated image feature information associated with the plurality of previous images.

9. The apparatus of claim 8, wherein the one or more processors are configured to:
perform a self-attention on the accumulated image feature information and the positional encodings to identify temporal information, the temporal information corresponding a temporal relationship of features within the accumulated feature information.

10. The apparatus of claim 9, wherein the one or more processors are configured to:
perform a cross-attention based on the temporal information and the feature representation of the current image to identify the relative motion.

11. The apparatus of claim 1, wherein the one or more processors are configured to:
update accumulated decoder information based on the accumulated feature information and a previous optical flow information associated with the previous image.

12. The apparatus of claim 11, wherein the one or more processors are configured to estimate the depth information for the current image further based on the accumulated decoder information and the optical flow information.

13. A method of processing one or more images by an image capturing device, comprising:
generating a feature representation of a current image;
updating accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images;
obtaining information associated with relative motion of the current image based on the accumulated feature information and the feature representation of the current image; and
estimating depth information for the current image based on the information associated with the relative motion and the accumulated feature information.

14. The method of claim 13, wherein a single image sensor obtains the current image.

15. The method of claim 13, wherein estimating the depth information for the current image comprises estimating a respective depth for each region of the current image.

16. The method of claim 15, wherein each region of the current image comprises a respective pixel of the current image.

17. The method of claim 13, wherein updating the accumulated feature information comprises:
modifying the previous image based on the optical flow information to obtain an estimated image;
obtaining first depth information based on the accumulated image feature information associated with the plurality of previous images and the current image; and
obtaining second depth information based on the accumulated optical flow information associated of the plurality of previous images and the estimated image.

18. The method of claim 17, wherein updating the accumulated feature information comprises:
determining a loss based on the first depth information and the second depth information, wherein the accumulated feature information is updated based on the loss.

19. The method of claim 18, wherein the loss is determined based on a difference between the first depth information and the second depth information.

20. A non-transitory computer-readable medium having stored thereon instructions that, when executed by one or more processors, cause the one or more processors to:
generate a feature representation of the current image;
update accumulated feature information for storage in a memory based on a feature representation of a previous image and optical flow information of the previous image, wherein the accumulated feature information comprises accumulated image feature information associated with a plurality of previous images and accumulated optical flow information associated of the plurality of previous images;
obtain information associated with relative motion of the current image based on the accumulated feature information and the feature representation of the current image; and
estimate depth information for the current image based on the information associated with the relative motion and the accumulated feature information.
